(19) United States
(12) Patent Application Publication
(10) Pub. No.: US 2015/0237268 A1
(43) Pub. Date: Aug. 20, 2015

(54) Multiple Camera Imaging

(71) Applicant: Reflective Practices, LLC, American Fork, UT (US)

(72) Inventors: Nayse Vaiaoga, Laie, HI (US); William James Jacob, Cranberry Township, PA (US); Beverly Ellison, American Fork, UT (US); Charles R. Jacob, American Fork, UT (US)

(21) Appl. No.: 14/628,155

(22) Filed: Feb. 20, 2015

Related U.S. Application Data
(60) Provisional application No. 61/942,504, filed on Feb. 20, 2014.

(51) Int. Cl. H04N 5/265

(52) U.S. Cl. CPC H04N 5/265

(57) ABSTRACT

Technology is described for combining content from a front camera and a rear camera of a mobile computing device. The method can include receiving an instruction via a graphical user interface to capture a plurality of content objects in response to a single instruction. The method can also include capturing a first content object from the front camera of the mobile device in response to the single instruction. The method can further include capturing a second content object from the back camera of the mobile device in response to the single instruction. The method can also include combining the first content object and second content object together into a combined viewable content object.

### PRIORITY CLAIM

Priority is claimed to U.S. Provisional Patent Application Ser. No. 61/942,504, filed Feb. 20, 2014, which is hereby incorporated herein by reference in its entirety.

### BACKGROUND

Individuals have been interested in taking photos of themselves and others ever since photography was invented. One way that a photographer can take a photo of the photographer who is also running the camera (i.e., include themselves in a photograph) is to use a timer. When the timer is set, then the photographer has a specific amount of time to get into the area being photographed before the camera takes a picture.

With the advent of hand-held cameras and cell phone cameras, individuals have often taken self-portraits of themselves by holding a camera at arms-length to capture a headshot or similar shot. More recently, this type of photograph has come to be known as a “selfie.” A selfie is considered to be a self-portrait photograph, typically taken with a digital camera or camera phone held at arms-length in a person's hand. Selfies are often associated with social networking Such photographs are often casual, are typically taken either with a camera held at arm's length or in a mirror, and typically include either only the photographer or the photographer and as many people as can be in focus or the frame. Selfies taken that involve multiple people may be known as “group selfies”.

### BRIEF DESCRIPTION OF THE DRAWINGS

FIG. 1 illustrates an example graphical user interface for viewing combined content from multiple cameras on a mobile device.

FIG. 2 illustrates an example graphical user interface for viewing side-by-side combined content from multiple cameras on a mobile device.

FIG. 3 illustrates an example graphical user interface for viewing a combined image and related social media information on a mobile device.

FIG. 4 illustrates an example graphical user interface for capturing an image from a front camera on a mobile device.

FIG. 5 illustrates an example graphical user interface for capturing an image from a back camera on a mobile device.

FIG. 6 illustrates an example graphical user interface for capturing an image from a front camera and a back camera on a mobile device.

FIG. 7 illustrates an example graphical user interface for editing a combined image and related social media information on a mobile device.

FIG. 8 illustrates an example graphical user interface for creating a social media posting for a combined image on a mobile device.

FIG. 8 illustrates an example graphical user interface for creating a slideshow on a mobile device.

FIG. 9a illustrates an example system for creating a combined image and related social media information on a mobile device.

FIG. 9b illustrates an example system for creating a combined content image or combined content objects where there are multiple front images and multiple back images.

FIG. 10 is block diagram illustrating an example of a computing device that may be used to execute a method for creating a combined image.

### DETAILED DESCRIPTION

A technology is provided that captures an image, video, or other content objects from separate cameras (e.g., on a mobile computing device). These images and/or videos from different perspectives can be combined into a single split-framed image for viewing by other users. These combination images may be called a “Backie” or “Backies” because one image may be captured using one or more front cameras of a mobile computing device (e.g., a cell phone or computing tablet) and another image may be captured using one or more rear cameras (e.g., the camera that is facing away from the user) of the mobile computing device. The images that are captured in this technology may also be captured from a scanner, a film camera or other cameras that may have captured previous photos taken previously. For example, images captured on a mobile computing device may also be combined with other pre-existing images. Further, multiple images or content object may be capture for a front grouping and multiple images can be captured for a back grouping. The front and back groupings may represent the front and back shots or captures of a place, an object, a person, animals, landscapes or other photographic subjects.

A split-framed image may be loaded into a social media application that enables users to create, post, and share the split-framed image. The combined image may be made up of an image taken with the front camera (Selfie) and an image taken with the back camera (Backie) of a mobile computing device. This creates a split-framed image in a single image file that can be used for individual social media posts (e.g., a Backie).

The split-framed image can be split vertically or horizontally, although the use of a horizontal orientation with the split-frame running horizontally may allow a larger portion of the image to be used in each frame for certain mobile devices. The horizontal split-frame orientation may also work well with different screen sizes or screen ratios where each image can occupy the full width of the device's screen. However, the user may also have the option in editing to resize the height of the frame, thus creating an image with either a rectangular or a more squared image. The position of the two images in the final combined image or image file can be switched.

If additional cameras are available that provide additional perspective views, these views may also be combined into the split-frame image. For example, a front, back, and one or more side images may be combined with horizontal split-frames to provide photographic views of location using four sides of a mobile device. These additional views may be shown in a frame roll format. The mobile computing device may include four physical cameras or the side perspective view may be taken by turning the mobile computing device to one or two sides with respect to the person taking the image.

Social media integration may enable a user to quickly post the split-framed image to a social media website created specifically for sharing split-framed images or an independent social media or image sharing application. Users may create a social media profile for sharing split-framed images using an email address, or by using credentials from another existing social media app on their device via a single-sign on. Users can post their split-frame images via their mobile device or post using their own profiles from a website created for storing split-frame images. Users may view other users' profiles and the users may be able to “like” a split-framed image, comment on a split-framed image, magnify a split-framed image (zoom in), share a split-framed image (email, message, download, or post it to another social media platform), and repost a split-framed image (posts someone else's split-framed image onto their own profile). In addition, inappropriate split-framed image can be reported by any user. The features contained in the application for sharing split-framed images may be common social media features that users may find familiar and intuitive to use.

Users may be able to add text over their split-framed images in an editing view. Text may be placed anywhere on the split-framed image, and the text may rotated to any angle or degree. The text may have different fonts and colors available. The application or a related website may also enable users to create a slideshow of split-framed images.

Users can also create short videos that can be placed in the split-frame content so that the presented content is now split-framed content containing videos, or a video and an image and vice-versa. An audio track may be added to a split-frame slide show and/or videos.

This technology enables users to see what is on the other side of a selfie picture. When a person takes a picture of himself or herself—a selfie, it is interesting to try to imagine or guess what is in front of the user. The surroundings or background in the user's selfie may tell part of the story, but this technology enables a glimpse of what exists on at least two sides of a mobile computing device at the same time. These combined split-framed images or videos tell us more of the story, or even a totally different story then what we may have imagined. Being able to capture both the selfie or the front camera, and the back camera when in a single location or (around about the same time) may also spur users to come up with interesting ways to tell a story through the user's photos.

While photo editing software may be used to create composite images, this technology enables the process of combined content creation from multiple cameras while the mobile computing device remains in a single location and with a low level of user effort. In one example, a reduced amount of effort is used because this application can prompt the user to take the selfie with the front camera first, and then prompt them to take a second photo with the back camera. Both photos can be automatically loaded into a split-frame and once the user finalizes the photo edits, the split-framed image may be posted to a sharing application or site using that same app.

In a similar example, the user may be prompted to take video from a front camera of a mobile device and then a second video from a rear camera of a mobile device. Both of these videos can be combined into a split-frame content presentation without additional user instructions. Of course, additional videos may be taken from additional video cameras on the mobile device and combined with the first and second cameras. Later when the video is played back, the two more videos can be played back simultaneously. Alternatively, the two videos can be played back sequentially and the two videos can represent different views of the same location.

While there are many photo sharing apps that allow users to create split pictures or framing, these applications do not guide a person to take two pictures from a single location or at about the same moment, and have all the user's posts be split-framed. In some configurations, the present technology may require that the user take two pictures from the two or more cameras on the mobile device. For example, the application may also require that at least one picture in the split-frame be from the front camera and a second picture in the split-frame be from the rear camera. So instead of just a stream of selfies being posted to a social media website, a user may post a selfie and a backie (picture from the back camera) put together. Thus, everyone's posts in such an online social community may also be split-framed pictures with the front and back content. The hope is to get users to share more than a selfie, and leave it to the user to use their creativity to tell their story.

This technology also enables users to see and post split-framed photos which can make a news feed of pictures different from existing photo sharing apps. Composite or multi-framed images can be hand created by users but now a centralized social media app can be provided that focuses on streaming these selfies and backies as combined together. This application can guide the user to take a picture with both the front and back cameras at about the same moment, making all posts split-framed. Thus, allowing the user to tell their story in a different way.

In one configuration, the application may take the photos from the front and back cameras during the same time period. For example, a graphical user interface may receive an instruction to capture the backie combination. At that point, instructions may be sent out to the two cameras to capture the two images as close in time as the computing device may allow (e.g., less than a second or two seconds apart). This means that both images may be captured virtually simultaneously from the user's viewpoint and then the images can be combined together into a split-frame image.

This technology allows users to quickly and easily capture both sides of the story to understand the full picture. The capturing of the multiple views is simpler and more centralized with the present technology and automatically guides the user to create the multiple images from multiple perspectives in split-frames.

Additionally, slide shows may be presented in each of the split-frames. A user may take a series of several pictures with the front camera and a series of pictures with the back camera and these may be shown in a slide show in the split-frames. For example, 5 images may be taken with the front camera and 5 images may be taken with the rear camera. Then these slides shows may be synchronized to show the slide show images in a synchronized manner (e.g., the first images from the front and back cameras may be shown followed by the second for the front and back cameras, and so forth). Similarly, pairs of photos may be linked together based on time and the pairs can be shown together in a slideshow.

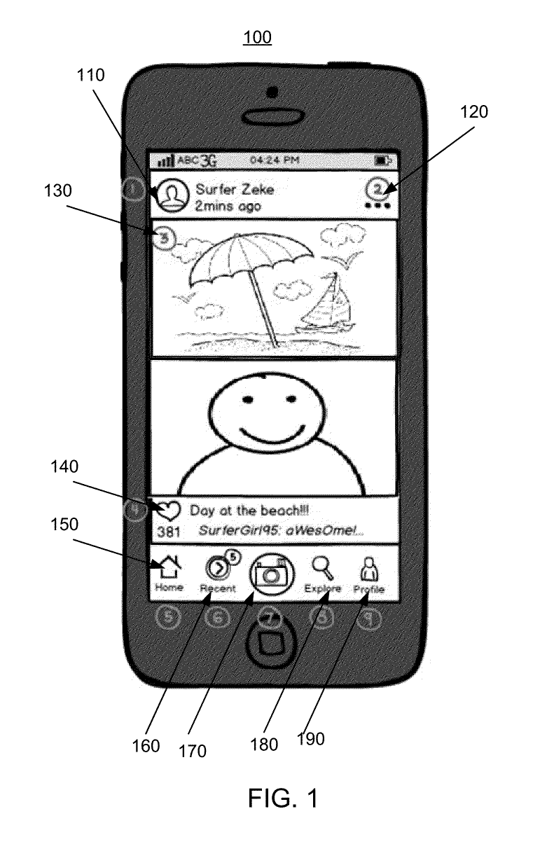

FIG. 1 illustrates an example graphical user interface 100 for viewing combined content from multiple cameras on a mobile device. By simply swiping up or down, a user is able to view other posts and engage with those posts. Posts can show two images, the selfie and the backie, side-by-side or one of the selfie or backie on top and the other of the selfie or backie on bottom. In one example, the images can be displayed vertically, i.e. in a portrait layout, or horizontally, i.e. in a landscape layout. FIG. 1 further shows that the graphical user interface 100 can include a profile bar 110 along the top portion of the application. The graphical user interface 100 can also include a menu 120, such as a dotted line. In one configuration, the menu 120 can enable the user to share the selfie and backie using sharing programs such as email or short message service (SMS). In another example, the menu 120 can enable the user to post the selfie and backie using social media programs such as Facebook, Twitter, Instagram, or Pinterest.

The graphical user interface 100 can also include a split-frame photo 130 taken by one or more users of the graphical user interface 100 and an interaction bar 140 where the one or more users or other viewers of the shared or posted split-frame photo 130 can like a post or comment about the split-frame photo 130. In one example, the one or more users or other viewers can click on the interaction bar 140 to like or comment on the split-frame photo 130. The graphical user interface 100 can also include a home button 150 that guides the view of the graphical user interface 100 to another page in the graphical user interface 100, such as a home page, the latest feed in the graphical user interface 100, or a recently posted split-frame photo 130. The graphical user interface 100 can also include a recent button 160 that shows recent activities of the one or more users of the graphical user interface 100, such as a user being followed by the other viewers.

The graphical user interface 100 can include a camera button 170 that accesses one or more of the cameras of a mobile computing device and takes one or more split-frame photos 130. In one example, when the user of the mobile computing device uses the camera button 170, a front camera of the mobile computing device can take a photo and a back camera of the mobile computing device can take another photo at substantially the same time. In another example, the front camera of the mobile computing device can take a photo and the back camera of the mobile computing device can take another photo sequentially. For example, the front camera can take a first photo and then the back camera can take a second photo after the first photo has been taken, or vice versa. The graphical user interface 100 can include an explore button 180 to enable the one or more users or the other viewers to perform a search for selected information or material, such as photos from another user, other photos by the same user, feeds, user profiles, locations the photos were taken, and so forth. The graphical user interface 100 can include a profile button 190 that enables the current user to edit selected profile information of the user. In one example, the graphical user interface 100 can also include adding text to the photo, sharing or posting video, and/or sharing or posting a slideshow.

While the camera source for an image, video or other content object may be a user's mobile imaging device, the camera source may be any other device that is able to create an image. The images or content objects may be retrieved from multiple devices (e.g., a mobile smart phone, a traditional camera, a desktop computer, an optical scanner, or any other camera imaging device. In other words, a backie or combined content object may be created using immediately captured photos as well as stored images that may have been taken at an earlier time, but combined through either the application or website.

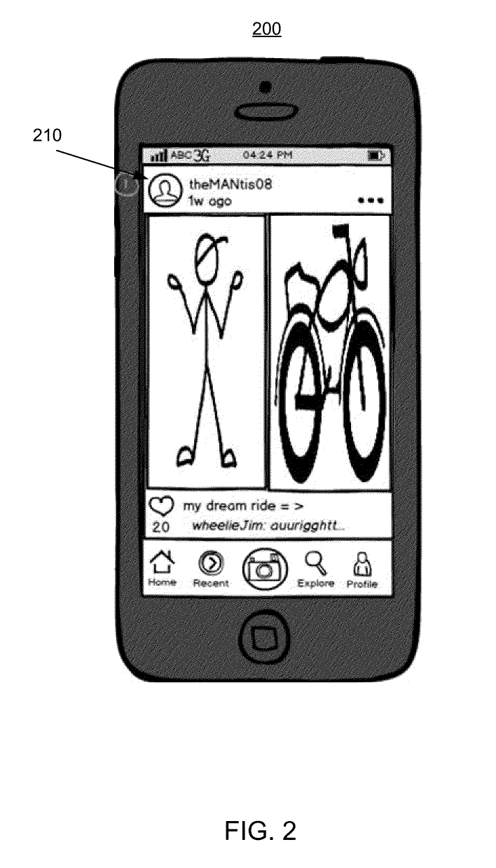

FIG. 2 illustrates an example graphical user interface 200 for viewing combined content from multiple cameras on a mobile device. FIG. 2 further shows that the graphical user interface 200 can include a profile bar 210 along the top portion of the application. FIG. 2 also shows a side-by-side split-frame photo of a selfie and backie. The graphical user interface 200 is substantially similar to the graphical user interface 100 in FIG. 1 described in the preceding paragraphs in other regards.

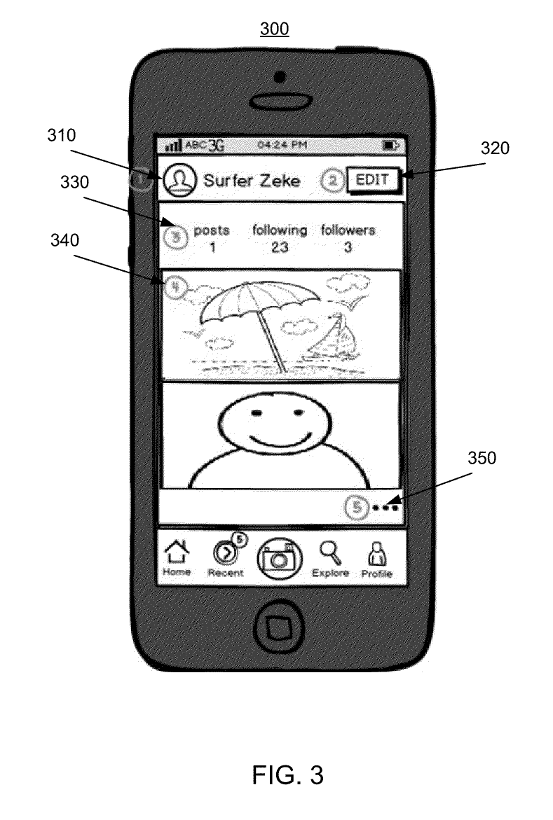

FIG. 3 illustrates an example graphical user interface 300 for editing one or more split-frame photos. FIG. 3 shows a graphical user interface 300 that can include a profile bar 310, such as at the top of the screen of the mobile computing device. The profile bar 310 can contain a name and/or icon picture of the current user of the graphical user interface 300. In one example, the user of the graphical user interface 300 can tap the profile bar 310 to change a profile setting, such as a profile picture, icon picture, user name, and so forth. The graphical user interface 300 can also include an edit button 320 that can enable the user to change the settings of the graphical user interface 300, such as a profile name, or perform tasks in the graphical user interface 300, such as logging out the user of a current user profile or deleting an account or profile. The graphical user interface 300 can include a status bar 330 that can show the number of posts by the user, how many other viewers or users are following a selected post, a selected split-frame photo, how many other viewers or other users are following the user, how many other viewers or other users the user is following, and so forth. The graphical user interface 300 can include an edit area 340 where a split-frame photo can be viewed and/or edited. The graphical user interface 300 can also include a menu button 350 that can provide the user with options, such as sharing the photo or deleting the photo.

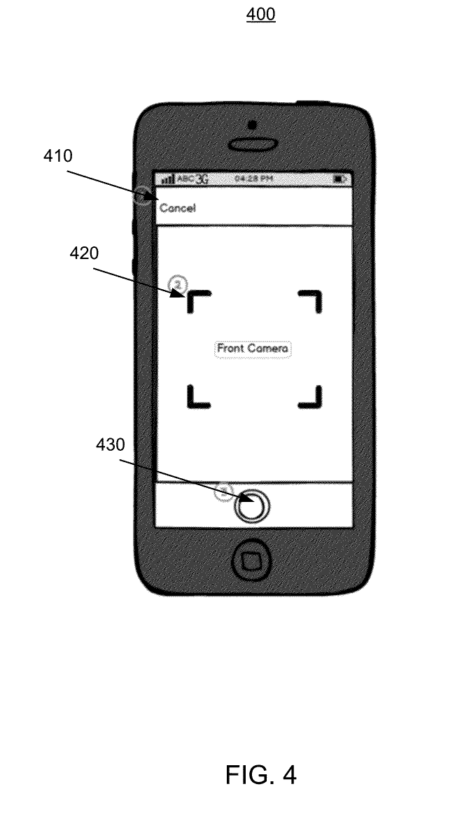

FIG. 4 illustrates an example graphical user interface 400 for displaying a view of a front camera of a mobile computing device. The graphical user interface 400 can include a front camera button 430 for taking one or more photos using a view finder 420 of the front camera of the mobile computing device. In one example, after a user uses the front camera button 430 to take a photo with the front camera, the graphical user interface 400 can enter an editing mode or and editing screen to enable the user to edit the photo. The graphical user interface 400 can include a cancel button 410 for returning a user to a home screen.

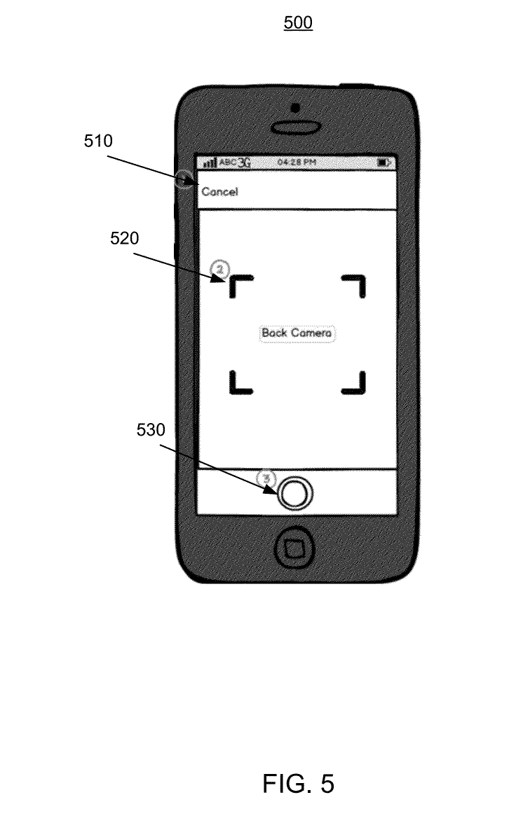

FIG. 5 illustrates an example graphical user interface 500 for displaying a view of a back camera of a mobile computing device. The graphical user interface 500 can include a back camera button 530 for taking one or more photos using a view finder 520 of the back camera of the mobile computing device. In one example, after a user uses the back camera button 530 to take a photo with the back camera, the graphical user interface 500 can enter an editing mode and/or an editing screen to enable the user to edit the photo. The graphical user interface 500 can also include a cancel button 510 for returning a user to a home screen.

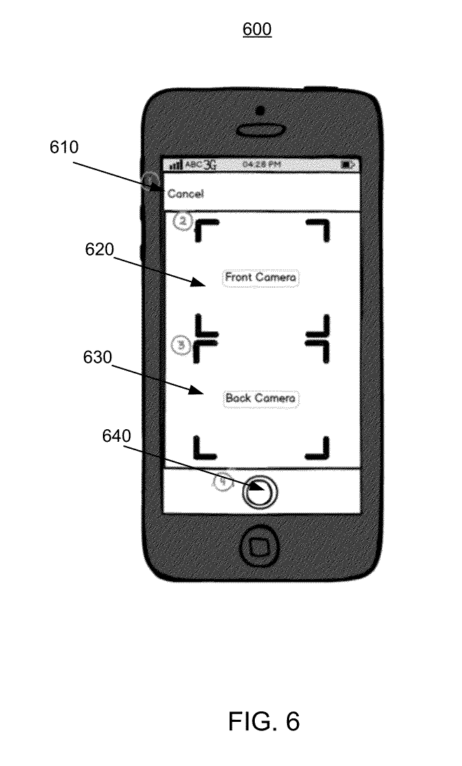

FIG. 6 illustrates an example graphical user interface 600 for displaying a view of a front camera and a view of a back camera of a mobile computing device simultaneously. The graphical user interface 600 can include a camera button 640 for taking one or more photos using a front view finder 620 of the front camera and one or more photos using a back view finder 630 of the back camera of the mobile computing device. In one example, after a user uses the camera button 640 to take a photo with the front camera and the back camera, the graphical user interface 600 can enter an editing mode or and editing screen to enable the user to edit the photo. The graphical user interface 600 can include a cancel button 610 for returning a user to a home screen.

In one example, a selfie and a backie images can each be tagged with association information to link the two images together. The association information can include a unique value or pointer to link the images, a geotag data, location data of where the selfie and/or backie was taken, time data of when the selfie and/or backie was taken, photo data identifying one or more individuals is in the selfie and/or backie, user data identifying the user profile of the user of the mobile device when the selfie and/or backie is taken, or other identifying data unique to the selfie and/or backie. In one example, a mobile computing device can link a selfie and a backie using the association information. For example, when a user of the mobile computing device takes a selfie and a backie at substantially the same time and/or location, the mobile computing device can tag each of the selfie and the backie with a geotag with the time and/or location when the selfie and the backie were taken by the user.

In one example, each of the selfie and backie may remain separate photographs and the selfie and the backie are linked together. In one example, the selfie and the backie are linked together using metadata, such as an exif header, for each of the selfie and the backie. One advantage of linking each of the selfie and the backie using data is that the linkage may enable a user of a graphical user interface to edit each seflie or backie separately and then combine the each seflie or backie into a split-frame object. Another advantage of linking the each of the selfie and backie while maintaining the separate selfie and backie photo or video is to enable a user to switch or replace a selfie or backie of a split-frame photo or video with another selfie or backie. In one example, a plurality of selfies and/or backies can be linked together using the association information. Users may also come back at a later point in time to edit a selfie and backie and the linkage described above may allow the backie to be added to other graphical templates or allow the relationship between the images to be maintained.

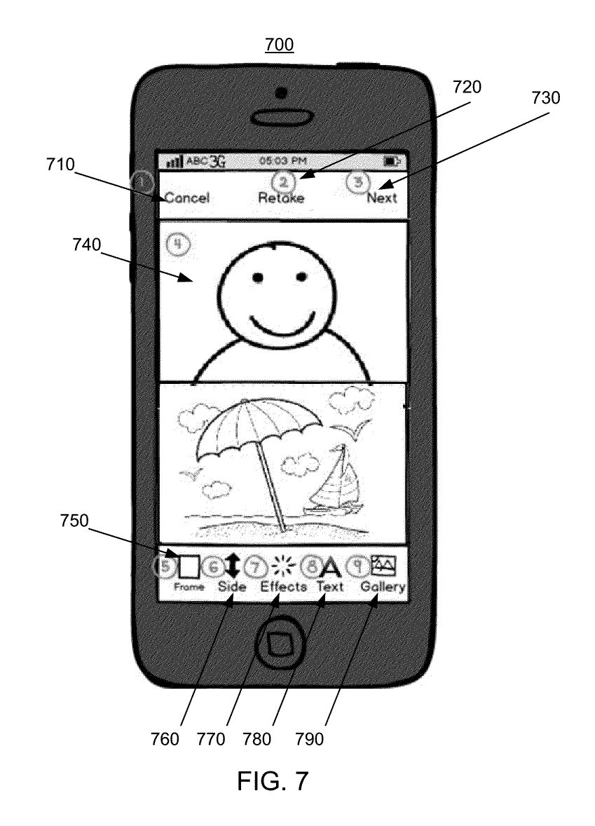

FIG. 7 illustrates an example graphical user interface 700 for editing one or more photos of a split-frame photo, such as a photo from a front camera or a back camera of a mobile computing device. The graphical user interface 700 can include a cancel button 710 to enable a user to return to a selected page or screen, such as a home screen. The graphical user interface 700 can include editing options. The editing options can include a retake button 720 to enable the user to retake one or more of the photos of a split-frame photo, such as retake a selfie photo or a backie photo. The editing options can include a framing button 750 for selecting a framing option, such as a vertical or horizontal layout of the photo. In one example, the default framing option can be a horizontal or portrait photo layout. In another example, the default framing option can be a vertical or landscape photo layout. The editing options can enable a user to move or resize one or more photos, such as by tapping the photo and dragging or pinching the photo. In one example, there can be a dotted or solid line that can divide the frame in two halves and adjusting this line may be enabled by the framing button. One of the halves can be a selfie and the other half can be a backie.

The editing options can include a side button 760 to enable a user to position the two halves side by side or position one half on the top part of the split-frame photo and the other half on the bottom of the split-frame photo. The side button 760 can also enable the user to select if the selfie is on the right and the backie is on the left of a horizontal layout, or vice versa. The side button 760 can also enable the user to select if the selfie is on the top and the backie is on the bottom of a vertical layout, or vice versa. The editing options can include an effects button 770 to enable the user to apply effects to one or more selected photos. The effects can include selecting the saturation level of a photo, the cool or warm level of a photo, the sepia of a photo, the contrast level of a photo, the brightness level of a photo, and so forth. In one example, the editing options can enable the user to move to another page or graphical user interface using a next button 730 when the user has finalized the split-frame photo or finished editing the one or more photos. The editing options can include a text button 780 to enable the user to incorporate or add text to the split-frame photo. In one example, the editing options can include an access camera roll button 790 to replace or select a selfie and/or backie from a camera roll for the split-frame photo. In one example, the editing options can be restricted based on the level of access the user has for the graphical user interface 700. For example, when the user is using a free version or basic version of the graphical user interface 700, the editing options may be restricted to the frame button 750, the side button 760, and the gallery button 790. In another example, when the user is using a purchased version or pro version of the graphical user interface 700, the editing options may be restricted to the frame button 750, the side button 760, the effects button 770, the text button 780, and the gallery button 790.

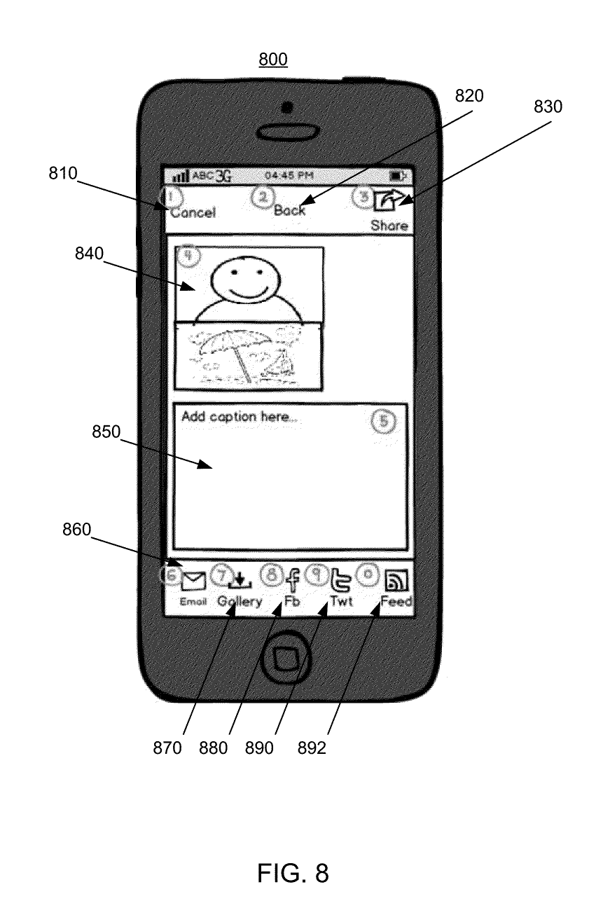

FIG. 8 illustrates an example graphical user interface 800 for sharing a split-frame photo. The graphical user interface 800 can include a cancel button 810 to enable a user to return to a selected page or screen, such as a home screen. The graphical user interface 800 can also include a back button 820 to enable the user to return to a previous page or screen, such as an edit screen. The graphical user interface 800 can also include a back button 830 to share posts of the split-frame photo, such as post the split-frame photo to a user profile. The graphical user interface 800 can also include a preview display 840 that displays a preview of what a split-frame photo the user has selected to share currently looks like. The graphical user interface 800 can also include an add caption box 850 that provides one or more users with an area to add a caption or comment to accompany the split-frame photo and an email or text button 860 to enable the user to email or text the split-frame photo to one or more selected email address or text numbers.

The graphical user interface 800 can also include a gallery button 870 to enable the user to save the split-frame photo to a camera roll. A Facebook button 880 can enable the user to share the split-frame photo to a Facebook account or page. The graphical user interface 800 can also include a Twitter button 890 to enable the user to share the split-frame photo to a twitter account or page and a Feed button 892 to enable the user to share the split-frame photo to a feed, such as a Rich Site Summary (RSS) feed, or other social media sites or programs. In one example, the mobile computing device can store login information of the user for one or more social media sites or programs, such as Facebook or Twitter, to enable the user to automatically login and share or post a split-frame photo when selecting Facebook button 880, Twitter button 890, or Feed button 892.

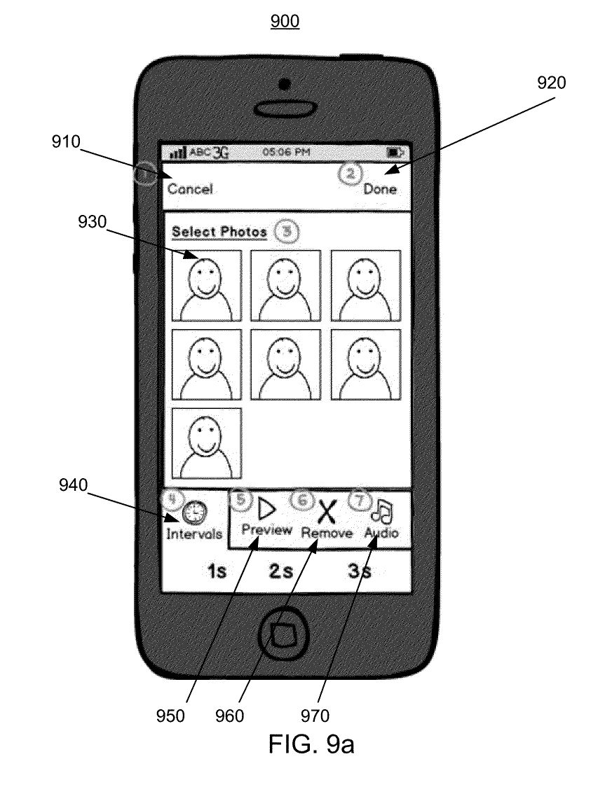

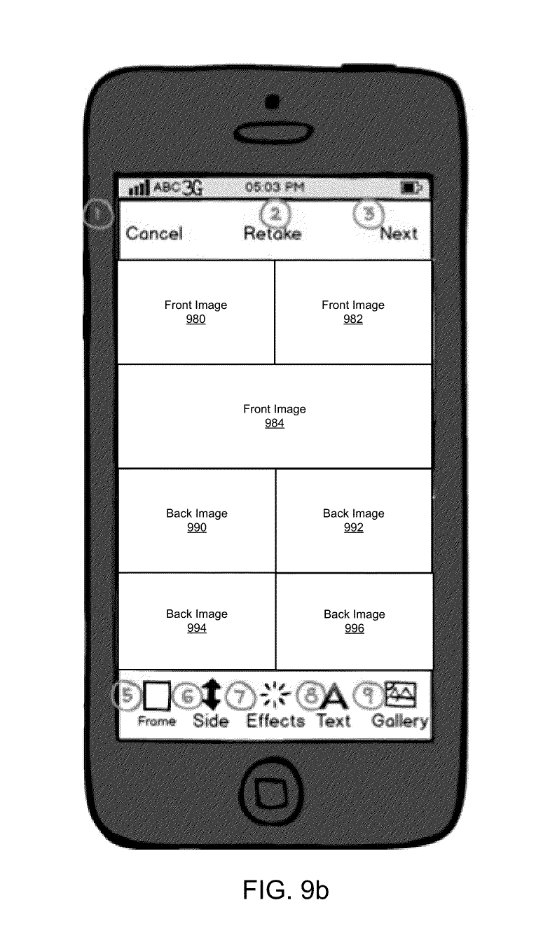

FIG. 9a illustrates an example graphical user interface 900 for creating and/or editing a slide show. The graphical user interface 900 can include a cancel button 910 to enable a user to return to a selected page or screen, such as a home screen and a done button 920 to enable a user to save a slideshow of photos or videos. When the user selects the done button 920 the graphical user interface 900 can proceed to a selected page or screen, such as a home screen or a sharing screen. The graphical user interface 900 can include a select photos area 930 to enable a user to select one or more photos or videos to include in a slideshow. The graphical user interface 900 can include an intervals button 940 to enable the user to select a time interval or transmission option to determine a time period each photo or video of the slideshow is displayed. A preview button 950 can enable the user to preview a slideshow the user has created or edited. In one example, the preview button 950 can cause the graphical user interface 900 to provide the user with a modal window displayed on a mobile computing device for the user to preview the slideshow. A remove button 960 may enable the user to remove unwanted photos or videos from a slideshow.

In addition to having a single-image or single content object on either the front frame or back frame, this technology may also allow for backies or combined content images of different types. Specifically, the combined content images may have multiple images, videos, or content objects on either the front frame, back frame, or both. For example, the multiple image option may provide a collage of images for either the front frame or back frame of the combined content image. FIG. 9B illustrates a combined content image or combined content objects where there are multiple front content objects 980-884 (e.g., images) and multiple back content objects 990-996 (e.g., images). While these content objects (e.g., images) are being shown as being square, the border of the content objects may be any geometrical or irregular shape. For example, the images, videos, or content objects may be combined together in a collage fashion. Thus, a user may have a collage of videos, images or other content objects that display the front and back of a location, object, animal, person etc.

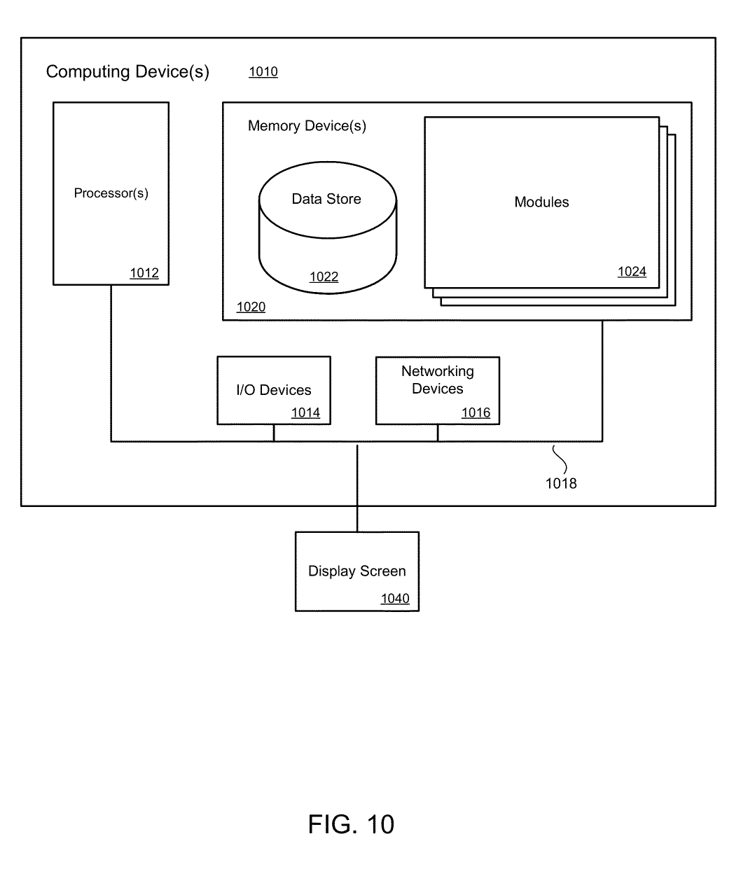

FIG. 10 illustrates a computing device 1010 on which modules of this technology may execute. A computing device 1010 is illustrated on which a high level example of the technology may be executed. The computing device 1010 may include one or more processors 1012 that are in communication with memory devices 1020. The computing device 1010 may include a local communication interface 1018 for the components in the computing device. For example, the local communication interface 1018 may be a local data bus and/or any related address or control busses as may be desired.

The memory device 1020 may contain modules that are executable by the processor(s) 1012. In one example, the memory device 1020 may contain a quantity extraction module, prediction module, quantity refinement module, index module and other modules that may be located in the memory device 1020. The modules 1024 may execute the functions described earlier. A data store 1022 may also be located in the memory device 1020 for storing data related to the modules and other applications along with an operating system that is executable by the processor(s) 1012.

Other applications may also be stored in the memory device 1020 and may be executable by the processor(s) 1012. Components or modules discussed in this description that may be implemented in the form of software using high programming level languages that are compiled, interpreted or executed using a hybrid of the methods.

The computing device may also have access to I/O (input/output) devices 1014 that are usable by the computing devices. An example of an I/O device is a display screen 1040 that is available to display output from the computing devices. Other known I/O device may be used with the computing device as desired. Networking devices 1016 and similar communication devices may be included in the computing device. The networking devices 1016 may be wired or wireless networking devices that connect to the internet, a LAN, WAN, or other computing network.

The components or modules that are shown as being stored in the memory device 1020 may be executed by the processor(s) 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for combining content from a front camera and a rear camera of a mobile computing device into a single view, comprising:
receiving an instruction via a graphical user interface to capture a plurality of content objects in response to the instruction;
capturing a first content object from the front camera of the mobile device in response to the single instruction;
capturing a second content object from the back camera of the mobile device in response to the instruction; and
combining the first content object and second content object together into a combined viewable content object.

2. The method as in claim 1, wherein the plurality of content objects are photographs, videos, or a slideshow.

3. The method as in claim 1, wherein the plurality of content objects are two photographs.

4. The method as in claim 1, wherein the first and second content objects are photographs that are combined into an image for viewing side by side.

5. The method as in claim 1, wherein the first and second content objects are photographs that are combined into an image with the second image being arranged below the first image.

6. The method as in claim 1, wherein the first content is a first plurality of content objects representing a front and the second content object is a second plurality of content objects representing a back.

7. A system for combining photos taken from a plurality of cameras comprising:
a mobile computing device having a processor and memory;
a first camera on a side of the mobile computing device having a primary screen of the mobile computing device;
a second camera on a second side of the mobile computing device separate from the primary screen of the mobile computing device; and
a graphical user interface configured to receive an instruction from a user to capture a first image from the first camera and a second image from the second camera;
an image capture module configured to guide a user to capture a first image for a first frame of a split-frame image and a second image for a second frame of a split-frame image; and
a photo stitching module configured to combine the first and second images into a single split-frame image for viewing by a user.
